(19) United States
(12) Patent Application Publication
(10) Pub. No.: US 2026/0311481 A1
(43) Pub. Date: Oct. 8, 2026

(54) SIGNAL PROCESSING DEVICE AND SIGNAL PROCESSING METHOD

(71) Applicant: Sony Semiconductor Solutions Corporation, Atsugi-shi, Kanagawa (JP)

(72) Inventor: Ryohei KAWASAKI, Kanagawa (JP)

(73) Assignee: Sony Semiconductor Solutions Corporation, Atsugi-shi, Kanagawa (JP)

(21) Appl. No.: 19/483,620

(22) PCT Filed: May 28, 2024
(86) PCT No.: PCT/JP2024/019482

§ 371 Date: Nov. 12, 2025

(30) Foreign Application Priority Data
Jun. 7, 2023 (JP) 2023-094237

(51) Int. Cl. G06V 10/94; G06V 10/147; G06V 10/774; G06V 10/82; H04N 23/71; H04N 23/84

(52) U.S. Cl. CPC G06V 10/955; G06V 10/147; G06V 10/774; G06V 10/82; H04N 23/71; H04N 23/843

(57) ABSTRACT

Processing accuracy of an image analysis process using an AI model is improved by using an image processing system comprising circuitry configured to acquire image data captured by an image sensor, process the image data to generate a non-demosaic image, and selectively output the non-demosaic image to an artificial intelligence model trained to perform image analysis.

### CROSS REFERENCE TO RELATED APPLICATIONS

This application claims the benefit of Japanese Priority Patent Application JP 2023-094237 filed on Jun. 7, 2023, the entire contents of which are incorporated herein by reference.

### Technical Field

The present technology relates to a signal processing device that performs an image analysis process using an AI model and a method thereof.

### Background Art

For example, a technique of performing an image analysis process such as an object detection process or an object recognition process on a captured image using an artificial intelligence (AI) model including a neural network such as a convolutional neural network (CNN) has been widely used.

In such an image analysis process, it is common to use 3 ch images of red (R), green (G), and blue (B) as input data of the AI model (see, for example, PTL 1 below).

### CITATION LIST

### Patent Literature

PTL 1: JP 2011-170890 A

### SUMMARY

### Technical Problem

Here, in a use in which a person views an image, it is desirable to use images of 3 ch of R, G, and B to be able to express full color. However, in terms of performance of the AI model, it may be not the best to use images of 3 ch of R, G, and B as input data.

The present technology has been made in view of the above circumstances, and it is desirable to improve processing accuracy of the image analysis process using an AI model.

### Solution to Problem

An image processing system includes circuitry configured to acquire image data captured by an image sensor, process the image data to generate a non-demosaic image, and selectively output the non-demosaic image to an artificial intelligence model trained to perform image analysis.

Since the demosaic process involves a spatial interpolation process, deviation from the original pixel value tends to occur, and in a case where the demosaiced image is used as input data of the image analysis process by the AI model, the processing accuracy may decrease due to the deviation of the pixel value. By using the non-demosaic image as the input data of the image analysis process as described above, it is possible to prevent degradation in processing accuracy due to such a demosaic process.

### BRIEF DESCRIPTION OF DRAWINGS

FIG. 1 is a block diagram illustrating a schematic configuration example of a camera device including a signal processing device as the first embodiment.

FIG. 2 is a diagram for describing an internal configuration example of an image signal processing unit included in the signal processing device as the first embodiment.

FIG. 3 is a diagram illustrating a result of an experiment on a change characteristic of the image analysis processing accuracy in a case where a type of input data of an AI processing unit is changed.

FIG. 4 is an explanatory diagram of a color separation image according to the embodiment.

FIG. 5 is a diagram for considering a factor of degradation in analysis processing accuracy that occurs in a case where a demosaiced image is used.

FIG. 6 is a flowchart illustrating a specific processing procedure example for realizing an analysis processing method as the first embodiment.

FIG. 7 is a block diagram for describing a configuration example of a camera device as the second embodiment.

FIG. 8 is a flowchart illustrating a specific processing procedure example for realizing an analysis processing method as a modification.

FIG. 9 is an explanatory diagram of an exemplary configuration in which an AI processing unit is provided outside a sensor device.

### DESCRIPTION OF EMBODIMENTS

Hereinafter, embodiments of a signal processing device according to the present technology will be described in the following order with reference to the accompanying drawings.
<1. First embodiment>
(1-1. Configuration example of camera device)
(1-2. Analysis processing method as first embodiment)
(1-3. Processing procedure)
<2. Second embodiment>
<3. Modifications>
<4. Summary of Embodiment>
<5. Present Technology>

### 1. First Embodiment

### (1-1. Configuration Example of Camera Device)

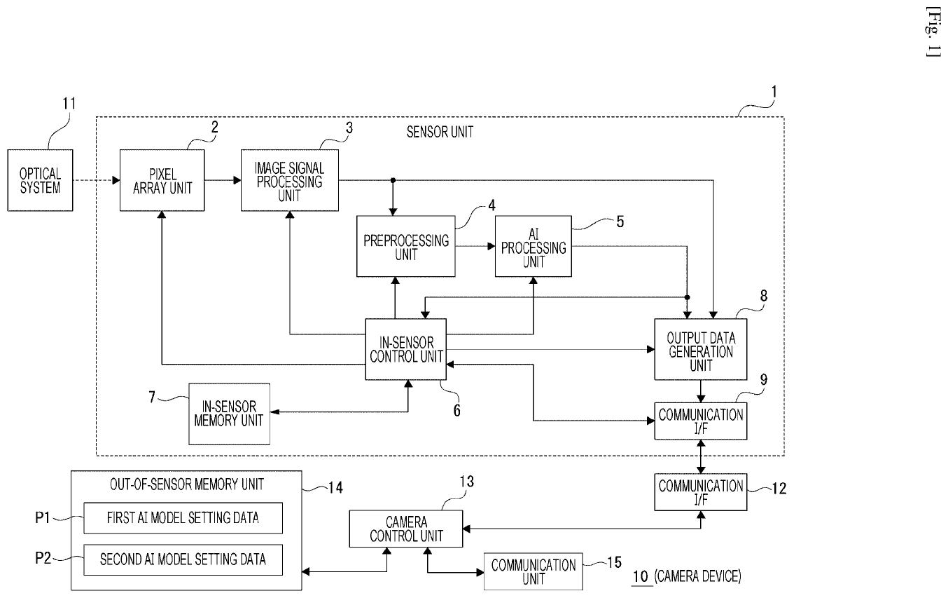

FIG. 1 is a block diagram illustrating a schematic configuration example of a camera device 10 including a signal processing device as the first embodiment according to the present technology.

As illustrated in the drawing, the camera device 10 includes an optical system 11, a communication interface (I/F) 12, a camera control unit 13, an out-of-sensor memory unit 14, and a communication unit 15 together with a sensor unit 1.

In the camera device 10, the sensor unit 1 corresponds to the signal processing device as the first embodiment.

The sensor unit 1 is configured as, for example, an image sensor such as a charge coupled device (CCD) type image sensor or a complementary metal oxide semiconductor (CMOS) type image sensor.

The sensor unit 1 is configured to be capable of performing not only an imaging function but also the image analysis process using an artificial intelligence (AI) model as image analysis process on a captured image.

Furthermore, in the sensor unit 1, a plurality of pixels that receives light of different wavelength bands is formed as pixels each of which has a light receiving element, and a captured image as a color image can be obtained.

In the camera device 10, the optical system 11 includes lenses such as a cover lens and a focus lens, and a diaphragm (iris) mechanism. Light (incident light) from a subject is guided by the optical system 11 and condensed on the light receiving surface of the sensor unit 1.

The communication interface (I/F) 12 is a communication interface for performing data communication between the sensor unit 1 and the camera control unit 13.

The camera control unit 13 includes, for example, a microcomputer including a central processing unit (CPU), a read only memory (ROM), and a random access memory (RAM), and performs overall control of the camera device 10 by the CPU executing various types of processing in accordance with a program stored in the ROM or a program loaded in the RAM.

The camera control unit 13 can receive various pieces of data from the sensor unit 1 and transmits various pieces of data to the sensor unit 1 via the communication interface 12.

The out-of-sensor memory unit 14 is connected to the camera control unit 13. The out-of-sensor memory unit 14 includes, for example, a non-volatile storage device such as a solid state drive (SSD) or a flash memory device, and is used to store information used for various kinds of control by the camera control unit 13. Furthermore, the out-of-sensor memory unit 14 can also be used to store various pieces of data obtained in the sensor unit 1, such as captured image data by the sensor unit 1.

In the camera device 10 of the present embodiment, first AI model setting data P1 and second AI model setting data P2 are stored in the out-of-sensor memory unit 14, which will be described later again.

Furthermore, the communication unit 15 is connected to the camera control unit 13.

The communication unit 15 is configured to be able to perform wired or wireless data communication with an external device. The communication unit 15 can also be configured to have a network communication function, and in this case, the camera control unit 13 can exchange data with a predetermined device (for example, the server device) on a predetermined network such as the Internet via the communication unit 15, for example.

As illustrated in the drawing, the sensor unit 1 includes a pixel array unit 2, an image signal processing unit 3, a preprocessing unit 4, an AI processing unit 5, an in-sensor control unit 6, an in-sensor memory unit 7, an output data generation unit 8, and a communication interface (I/F) 9.

In the pixel array unit 2, for example, a plurality of pixels each of which has a light receiving element (photoelectric conversion element) such as a photodiode is two-dimensionally disposed in the horizontal direction and the vertical direction.

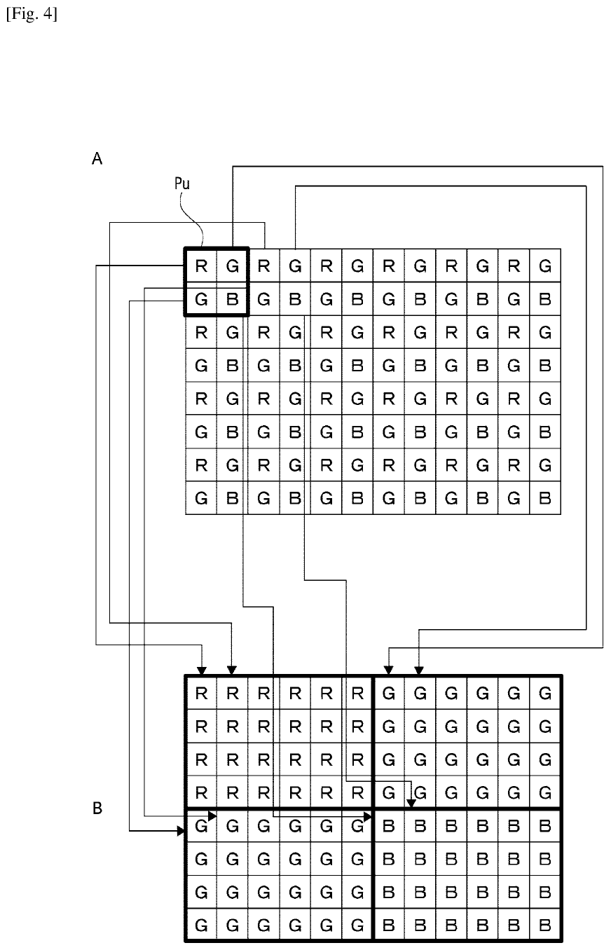

Specifically, the pixel array unit 2 includes a pixel unit Pu (see FIG. 4A to be described later) in which a plurality of pixels that receives light of different wavelength bands is two-dimensionally disposed in a predetermined pattern, and a plurality of the pixel units Pu is two-dimensionally disposed.

In the present embodiment, the pixel unit Pu is formed by disposing three types of pixels of an R pixel that receives R (red) light, a G pixel that receives G (green) light, and a B pixel that receives B (blue) light in a predetermined array pattern. Specifically, the pixel unit Pu in the present example is formed by disposing R pixels, G pixels, and B pixels in a Bayer array.

The pixel array unit 2 also includes a configuration for obtaining image data as digital data, such as a readout circuit for reading out a value (received light value) of each pixel and an analog to digital converter (ADC) for digitally sampling a pixel value as an analog signal.

An image signal processing unit (ISP: Imaging Signal Processor) 3 receives image data (captured image data) obtained by the pixel array unit 2, and performs various types of image signal processes.

Note that the internal configuration of the image signal processing unit 3 will be described again later.

The preprocessing unit 4 receives image data after the image signal process by the image signal processing unit 3, and performs an image signal process as preprocessing for the image analysis process by the AI processing unit 5. Specifically, the pre-processing unit 4 in the present example is configured to be able to perform at least image resizing processing.

The AI processing unit 5 performs the image analysis process using the AI model using the image data output from the preprocessing unit 4 as input data.

The AI processing unit 5 includes, for example, a digital signal processor (DSP), and can switch an AI model used for the image analysis process by switching processing parameters.

The AI processing unit 5 of the present example is configured to be able to perform the image analysis process using an AI model including a neural network such as a convolutional neural network (CNN), for example.

Here, as an example, it is assumed that the camera device 10 in the present example is disposed in a commercial facility such as a supermarket or a department store and performs the image analysis process with a person as a customer as a target subject. Specifically, it is assumed that the object detection process with a person as a target subject is performed.

In this case, as the AI model in the AI processing unit 5, an AI model machine trained to perform an object detection process with a person as a target subject is used. Here, the object detection process includes a process of identifying a region where the target subject is present as a so-called bounding box.

The in-sensor control unit 6 includes a microcomputer including, for example, a CPU, a ROM, a RAM, and the like, and integrally controls the operation of the sensor unit 1.

For example, the in-sensor control unit 6 controls the operation of the pixel array unit 2. Specifically, control of start/stop of operation and the like are performed.

Furthermore, the in-sensor control unit 6 also controls the operations of the image signal processing unit 3, the preprocessing unit 4, and the AI processing unit 5. Regarding the operation control of the image signal processing unit 3 and the pre-processing unit 4, the in-sensor control unit 6 can control process parameters of various types of processing.

Furthermore, as the control of the AI processing unit 5, the in-sensor control unit 6 can perform switching control of the AI model.

The in-sensor memory unit 7 is connected to the in-sensor control unit 6. The in-sensor memory unit 7 includes, for example, a non-volatile storage device such as a flash memory device, and is used to store information used for various kinds of control by the in-sensor control unit 6.

The output data generation unit 8 receives the analysis process result by the AI processing unit 5 and the image data output from the image signal processing unit 3, and generates output data to be output to the outside of the sensor unit 1. The output data generation unit 8 generates output data on the basis of an instruction from the in-sensor control unit 6. For example, it is conceivable to switch whether or not to use both the analysis process result by the AI processing unit 5 and the image data as output data or use only the analysis process result by the AI processing unit 5 as output data on the basis of an instruction from the in-sensor control unit 6.

The communication interface 9 is a communication interface for enabling data output from the inside of the sensor unit 1 to the outside of the sensor unit 1 and data input from the outside of the sensor unit 1 to the inside of the sensor unit 1, and performs data communication according to a predetermined communication data format with the communication interface 12 described above.

The above-described output data can be output to the outside of the sensor unit 1 (the camera control unit 13 in this example) via the communication interface 9.

Furthermore, the in-sensor control unit 6 can perform data communication with the camera control unit 13 via the communication interface 9.

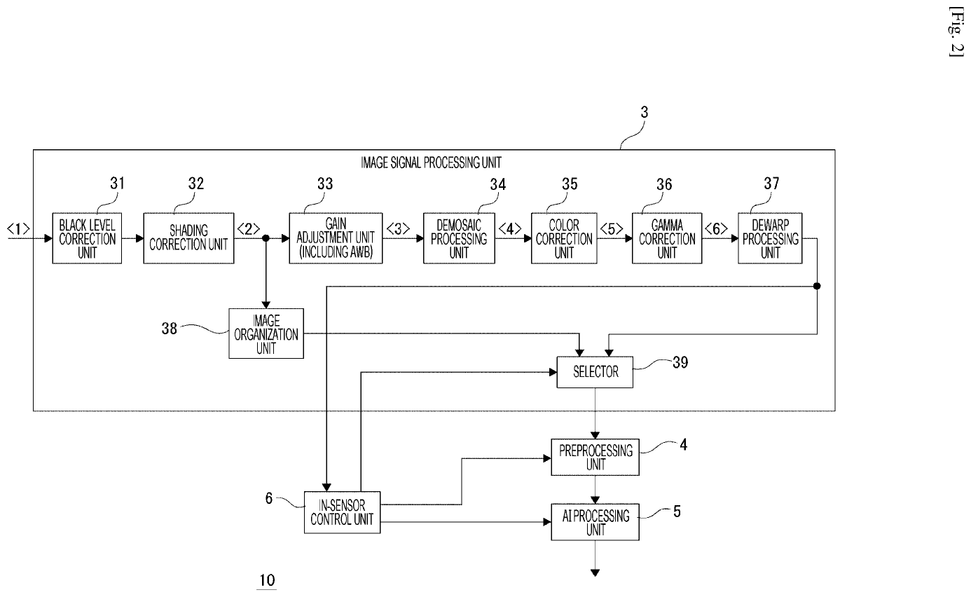

FIG. 2 is a diagram for describing an internal configuration example of the image signal processing unit 3.

Note that FIG. 2 illustrates the preprocessing unit 4, the AI processing unit 5, and the in-sensor control unit 6 illustrated in FIG. 1 together with the internal configuration example of the image signal processing unit 3.

Image data as RAW data is input to the image signal processing unit 3 from the pixel array unit 2 illustrated in FIG. 1. The RAW data referred to herein means image data obtained by reading the value of each pixel in raster order, that is, in the present example, image data in a state where the pixel array in the Bayer array is maintained.

As illustrated, the image signal processing unit 3 includes a black level correction unit 31, a gain adjustment unit 33, a demosaic processing unit 34, a color correction unit 35, a gamma correction unit 36, and a dewarp processing unit 37, and can sequentially perform a shading correction process, a gain adjustment process, a demosaic process, a color correction process, a gamma correction process, and a dewarping process on image data as RAW data input by the pixel array unit 2.

Here, the gain adjustment process by the gain adjustment unit 33 includes overall gain adjustment for adjusting the luminance distribution of the entire image regardless of the color of the pixel, and an auto white balance (AWB) process that is the gain adjustment process for each color.

Furthermore, the demosaic process by the demosaic processing unit 34 is a process of generating image data as an R image, a G image, and a B image with the same number of pixels as the input image data by performing a spatial interpolation process for each color of R, G, and B from the input image data in the Bayer array state.

The color correction unit 35 performs a color correction process by a linear matrix process on the image data subjected to the demosaic process.

Furthermore, the dewarp processing unit 37 performs at least a lens distortion correction process as the dewarping process.

Here, the image signal processing unit 3 in the present embodiment also includes an image organization unit 38 and a selector 39, which will be described later again.

### (1-2. Analysis Processing Method as First Embodiment)

As described above, in the application in which a person appreciates an image, it is desirable to use images of 3 ch of R, G, and B because full color expression can be performed. However, in the image analysis process using an AI model, it is not necessarily the best in terms of analysis processing accuracy to use images of 3 ch of R, G, and B as input data.

In view of this point, the present embodiment proposes a method of using a non-demosaic image that is a captured image in a state not subjected to a demosaic process as input data of the AI processing unit 5.

Since the demosaic process involves a spatial interpolation process, deviation from the original pixel value tends to occur, and in a case where a demosaiced image is used as input data of the image analysis process by the AI model, the accuracy of the image analysis process may decrease due to the deviation of the pixel value.

On the other hand, by using the non-demosaic image as the input data of the AI processing unit 5 as described above, it is possible to prevent degradation in processing accuracy due to such a demosaic process, and it is possible to improve the processing accuracy of the image analysis process using the AI model.

Furthermore, in the present embodiment, the input data of the AI processing unit 5 is switched between a demosaiced image that is an image after the demosaic process by the demosaic processing unit 34 and a non-demosaic image on the basis of the scene determination result for the scene to be imaged.

Here, in a case where the image analysis process using the AI model is performed in the sensor device as in the present embodiment, a resource (memory amount and calculation capability) that can be allocated to the image analysis process tend to be in-sufficient.

For example, in the image analysis process using an AI model, such as an object detection process, it is practically requested to maintain accuracy even in a case where a certain degree of change occurs in a scene captured by a camera. For example, a scene captured by a camera, such as a bright/dark scene such as day and night, a scene in which a subject to be analyzed such as a person is present relatively far away, or a scene in which the subject to be analyzed such as a person is present nearby, can change over time. It is desirable that the analysis processing accuracy is maintained at a certain level or more even with respect to such a change in the scene.

In order to maintain the accuracy with respect to the scene change, it is conceivable to perform machine training with the captured image of each scene to be handled as the input data for training the as the training of the AI model and create the AI model capable of absorbing the difference between the scenes.

However, in order to be able to absorb the difference between the scenes in this manner, a relatively large number of filter coefficients and a relatively large number of network hierarchies are requested as the AI model, and resources requested for realizing the AI model increase.

Therefore, the method of absorbing the change in the scene in the AI model can be applied in a case where the execution entity of the image analysis process is a computer device having a relatively rich resource, specifically, a computer device outside the camera device 10, but is difficult to be applied in a case where the image analysis process is performed in the camera device 10 having a limited resource, particularly, in a case where the image analysis process is performed in the sensor device (sensor unit 1).

Therefore, in the present embodiment, a method of switching the input data of the AI processing unit 5 between the demosaiced image and the non-demosaic image on the basis of the scene determination result as described above is used.

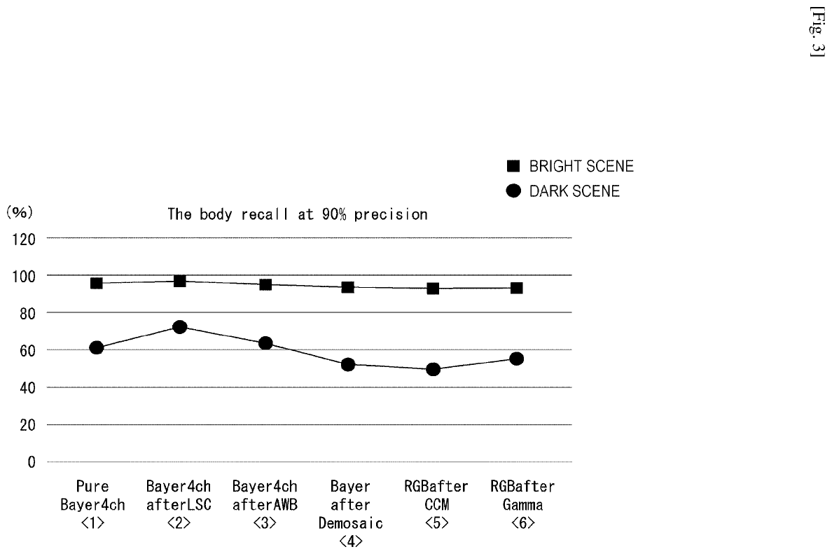

FIG. 3 illustrates a result of an experiment on a change characteristic of image analysis processing accuracy in a case where the type of input data of the AI processing unit 5 is changed.

Specifically, the experimental result of FIG. 3 illustrates a result in a case where the object detection process with the human body as the target subject is performed as the image analysis process using the AI model, and illustrates a measurement result of the evaluation value of the image analysis processing accuracy in a case where the image data of each extraction position indicated by <1> to <6> in FIG. 2 is used as the input data for each scene of the dark scene and the bright scene.

The evaluation value here is obtained as a ratio at which 90% or more of persons can be accurately detected in a case where the object detection process with the human body as the target subject is performed a plurality of times.

Here, the dark scene means a scene in which the target subject appears dark, and can be defined as, for example, a scene in which the luminance value of the target subject is equal to or less than a certain value. The bright scene means a scene in which the target subject appears brightly, and can be defined as, for example, a scene in which the luminance value of the target subject exceeds the certain value.

As can be seen with reference to FIG. 2, the extraction position of <1> is a position immediately before input to the image signal processing unit 3, and the extraction position of <2> is a position between a shading correction unit 32 and the gain adjustment unit 33. The extraction position of <3> is a position between the gain adjustment unit 33 and the demosaic processing unit 34.

The extraction positions of <1> to <3> are both positions before demosaicing. In the experiment, image data as a color separation image to be described below is used as the image data of the extraction positions of <1> to <3> in correspondence with the use of the AI model having the CNN as the AI model.

FIG. 4 is an explanatory diagram of a color separation image according to the embodiment.

FIG. 4A illustrates a pixel array (Bayer array in this example) in the pixel array unit 2. As illustrated, in the present example, the pixel unit Pu is formed by disposing four pixels of R, G, G, and B in a predetermined array pattern according to the Bayer format.

Here, the color separation image means an image formed by collecting pixel values at the same pixel unit position the from respective pixel units Pu and disposing the pixel values in different regions on the same image plane.

FIG. 4B illustrates a color separation image generated in the case of the Bayer array. In the case of the Bayer array as illustrated, pixel values of pixels having the same pixel unit position are collected and disposed in different regions on the same image plane for the R pixel, the G pixel, the G pixel, and the B pixel in respective pixel units Pu, thereby generating a color separation image including an image region in which pixel values of the R pixels in respective pixel units Pu are arrayed, an image region in which pixel values of one G pixel in respective pixel units Pu are arrayed, an image region in which pixel values of the other G pixel in respective pixel units Pu are arrayed, and an image region in which pixel values of the B pixel in respective pixel units Pu are arrayed.

By using the color separation image as described above as the input data of the AI processing unit 5, the format of the input data to the AI processing unit is an input data format suitable for the configuration of the CNN, and the accuracy of the image analysis process can be improved.

The description is returned to FIG. 3.

The extraction positions of <4> to <6> are extraction positions after demosaicing, <4> is a position between the demosaic processing unit 34 and the color correction unit 35, <5> is a position between the color correction unit 35 and the gamma correction unit 36, and <6> is a position between the gamma correction unit 36 and the dewarp processing unit 37.

According to the result of FIG. 3, in the bright scene, the evaluation value is 90% or more regardless of the data type of the input data from <1> to <6>. From this point, in the case of the bright scene, it can be seen that the accuracy of the object detection process tends not to depend on the difference in data type.

On the other hand, in the case of the dark scene, a significant decrease in the evaluation value can be confirmed at and after the extraction position of <4>. That is, in a case where the demosaiced image is used as the input data, the processing accuracy is significantly reduced.

According to an experiment, in the case of the data types <1> to <3> before demosaicing, the evaluation value is maintained at 60% or more, whereas in the case of the data type <4><5> after demosaicing, the evaluation value is significantly lower than 60%. In the case of using the data type of <6>, that is, the demosaiced image after gamma correction, a slight increase in the evaluation value can be confirmed, but is less than 60%.

In the dark scene, the case of using the data type of <2>, that is, the image after shading correction and before gain adjustment has the highest evaluation value, and the evaluation value is about 75%.

As in the above experimental results, it is considered that the accuracy of degradation in the image analysis process in a case where the demosaiced image is used because the deviation from the original pixel value due to the spatial interpolation process as the demosaic process is remarkable in the dark scene.

In addition, under limited resources, the input data to the AI processing unit 5 is resized (for example, thinned out) to a predetermined size in the preprocessing unit 4 so as to reduce the amount of input data to the AI processing unit 5. It is considered that degradation in the processing accuracy in the case of using the demosaiced image occurs due to this point.

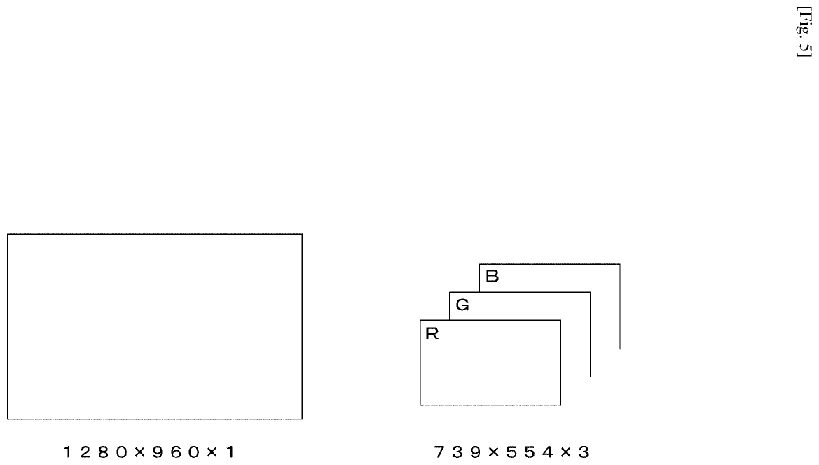

As a specific example, for example, on the premise that the amount of input data of the AI processing unit 5 is limited to the amount of data of 1280×960 pixels, in a case where a non-demosaic image is used as illustrated in FIG. 5, an image with a resolution (information density) of 1280×960 pixels can be used as the input data, while in a case where the demosaiced image is used, the resolution of each of the R image, the B image, and the G image to be the input data of the AI processing unit 5 is reduced to 739×554 pixels.

The degradation in resolution in this manner is also considered to be a cause of degradation in processing accuracy in a case where a demosaiced image is used as input data.

Considering the above points, in the present embodiment, as the determination of the scene to be imaged, a method is used in which it is determined whether or not it is a dark scene, and a non-demosaic image is input as input data of the AI processing unit 5 in a case where the scene is determined to be the dark scene.

As a result, in a case where an AI model capable of absorbing a difference between scenes cannot be used due to a resource problem, it is possible to suppress degradation in image analysis processing accuracy in a dark scene, and it is possible to suppress degradation in image analysis processing accuracy depending on a scene.

In the present example, the non-demosaic image after shading correction indicated as <2> is used as the input data in the dark scene. Specifically, the color separation image of the non-demosaic image obtained between the shading correction unit 32 and the gain adjustment unit 33 is used as input data in the dark scene.

Therefore, in the camera device 10 of the present embodiment, the image signal processing unit 3 is provided with the image organization unit 38.

As illustrated in FIG. 2, the image organization unit 38 receives the non-demosaic image after the shading correction output from the shading correction unit 32, and re-arranges the pixel values by the method described above with reference to FIG. 3, thereby generating a color separation image for the non-demosaic image after the shading correction.

Furthermore, in the present embodiment, in a case where it is determined that the scene is not a dark scene as a result of the determination as to whether or not it is a dark scene, the demosaiced image is input as the input data of the AI processing unit 5. Specifically, in the present example, in a case where it is determined that it is not a dark scene, the demosaiced image output from the dewarp processing unit 37 is provided as input data of the AI processing unit 5.

In order to enable such input data switching according to the dark scene/bright scene, the image signal processing unit 3 is provided with a selector 39.

The selector 39 receives inputs of the non-demosaic image that is the color separation image in the image organization unit 38 and the demosaiced image output from the dewarp processing unit 37 to output the image instructed by the in-sensor control unit 6 to the preprocessing unit 4.

In the present example, the in-sensor control unit 6 determines whether or not it is a dark scene on the basis of the demosaiced image. Specifically, the in-sensor control unit 6 in the present example determines whether or not it is a dark scene on the basis of the demosaiced image output by the dewarp processing unit 37.

Then, as a result of determining whether or not it is a dark scene, the in-sensor control unit 6 causes the selector 39 to output (select) the demosaiced image in a case where it is determined that the scene is not a dark scene, and causes the selector 39 to output (select) the non-demosaic image in a case where it is determined that the scene is a dark scene.

Furthermore, in the present embodiment, the in-sensor control unit 6 performs control so that an AI model trained with a demosaiced image as input data for training is used as the AI model in a case where the demosaiced image is used as input data of the AI processing unit 5, and an AI model trained with a non-demosaic image as input data for training is used as the AI model in a case where the non-demosaic image is used as input data of the AI processing unit 5.

In the present example, the setting data of the AI processing unit 5 for realizing the former AI model, that is, the AI model trained with the demosaiced image as the input data for training is stored as the first AI model setting data P1 in the out-of-sensor memory unit 14 illustrated in FIG. 1, and the setting data of the AI processing unit 5 for realizing the latter AI model, that is, the AI model trained with the non-demosaic image as the input data for training is stored as the second AI model setting data P2 in the out-of-sensor memory unit 14.

Here, the first AI model setting data P1 and the second AI model setting data P2 are data including parameters as filter coefficients used in a filtering process such as a convolution process in the CNN and various parameters related to the structure of the neural network.

In a case where it is determined that the scene is not a dark scene, the in-sensor control unit 6 instructs the camera control unit 13 via the communication interface 9 to read the first AI model setting data P1 from the out-of-sensor memory unit 14 and transfer the first AI model setting data P1 to the in-sensor control unit. Then, by performing parameter setting of the AI processing unit 5 according to the transferred first AI model setting data P1, the AI processing unit 5 can execute the image analysis process by the AI model trained with the demosaiced image as the input data for training.

Furthermore, in a case where it is determined that it is a dark scene, the in-sensor control unit 6 instructs the camera control unit 13 via the communication interface 9 to read the second AI model setting data P2 from the out-of-sensor memory unit 14 and transfer the second AI model setting data P2 to the in-sensor control unit, and sets the parameters of the AI processing unit 5 according to the transferred second AI model setting data P2, so that the AI processing unit 5 can execute the image analysis process by the AI model trained with the non-demosaic image as the input data for training.

### (1-3. Processing Procedure)

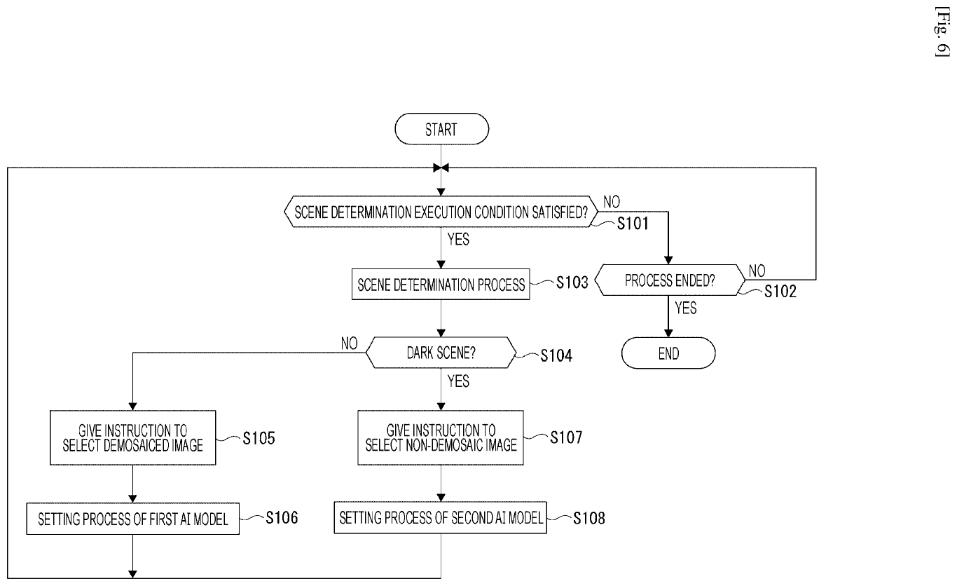

A specific processing procedure example to be executed by the in-sensor control unit 6 to realize the analysis processing method as the first embodiment described above will be described with reference to the flowchart of FIG. 6.

Note that the processing illustrated in FIG. 6 is executed by the CPU in the in-sensor control unit 6 on the basis of a program stored in a predetermined storage device such as the ROM of the in-sensor control unit 6. However, in the following description, it is expressed that the execution entity of the process is the in-sensor control unit 6 for the sake of explanation.

In the present example, the in-sensor control unit 6 starts the processing illustrated in FIG. 6 in response to activation.

First, in step S101, the in-sensor control unit 6 determines whether or not the scene determination execution condition is satisfied. That is, it is determined whether or not a predetermined condition determined in advance as a condition that a scene determination process (a process of determining whether or not the scene is a dark scene in this example) in step S103 described later is to be executed is satisfied.

The scene determination process in step S103 may be periodically performed at pre-determined time intervals, for example. In this case, the scene determination condition is only required to be the passage of a certain period of time.

Note that it is also conceivable that the scene determination execution condition is that an instruction from the outside has been given, that as a result of simple brightness detection using an illuminance sensor or the like, there has been a change in brightness by a predetermined amount or more, or the like, and the scene determination execution condition is not limited to a specific condition.

In a case where it is determined in step S101 that the scene determination execution condition is not satisfied, the in-sensor control unit 6 proceeds to step S102 and determines whether or not the process is ended, that is, whether or not a predetermined condition determined in advance as a condition that the series of processes illustrated in FIG. 6 should be ended, such as power-off, for example, is satisfied.

In a case where it is determined in step S102 that the process is not ended, the in-sensor control unit 6 returns to step S101.

That is, a loop process of waiting for either the establishment of the scene determination execution condition or the establishment of the processing end condition is formed by the processes of steps S101 and S102.

In a case where it is determined in step S101 that the scene determination execution condition is satisfied, the in-sensor control unit 6 proceeds to step S103 and executes the scene determination process. That is, in the present example, it is determined whether or not the scene is a dark scene on the basis of the demosaiced image output from the dewarp processing unit 37. Specifically, it is determined whether or not the average luminance value of the region of the target subject is equal to or less than a predetermined luminance value. At this time, it is conceivable to identify the region of the target subject on the basis of, for example, region information of the target subject obtained as a result of the object detection process by the AI processing unit 5. Note that, in a state where the object detection process by the AI processing unit 5 is not started, for example, it is conceivable to identify the region of the moving body detected by the moving body detection process by the inter-frame difference detection process or the like as the region of the target subject.

In step S104 following step S103, the in-sensor control unit 6 determines whether or not it is a dark scene. That is, it is determined whether or not a determination result indicating a dark scene has been obtained as a result of the determination process in step S103.

In a case where it is determined in step S104 that it is not a dark scene, the in-sensor control unit 6 proceeds to step S105 and gives an instruction to select a demosaiced image. That is, it instructs the selector 39 to selectively output the demosaiced image input from the dewarp processing unit 37.

Then, in step S106 subsequent to step S105, the in-sensor control unit 6 performs a setting process of the first AI model. That is, the control unit instructs the camera control unit 13 via the communication interface 9 to read the first AI model setting data P1 from the out-of-sensor memory unit 14 and transfer to the control unit, and performs parameter setting of the AI processing unit 5 according to the transferred first AI model setting data P1.

As a result, in a case where it is determined that the scene is not a dark scene, the AI processing unit 5 performs the image analysis process using the AI model trained with the demosaiced image as input data and the demosaiced image as input data for training.

The in-sensor control unit 6 returns to step S101 in response to the execution of the setting process in step S106.

Furthermore, in step S104 described above, in a case where it is determined that the scene is the dark scene, the in-sensor control unit 6 proceeds to step S107, and instructs the selector 39 to select the non-demosaic image, that is, to select and output the non-demosaic image by the color separation image input from the image organization unit 38.

Furthermore, in step S108 following step S107, the in-sensor control unit 6 performs a setting process of the second AI model. That is, the control unit instructs the camera control unit 13 via the communication interface 9 to read the second AI model setting data P2 from the out-of-sensor memory unit 14 and transfer to the control unit, and performs parameter setting of the AI processing unit 5 according to the transferred second AI model setting data P2.

As a result, in a case where it is determined that the scene is a dark scene, the AI processing unit 5 performs the image analysis process using the AI model trained with the non-demosaic image by the color separation image as input data and the non-demosaic image by the color separation image as input data for training.

The in-sensor control unit 6 returns to step S101 in response to the execution of the setting process in step S108.

In addition, in a case where it is determined in step S102 that the process is ended described above, the in-sensor control unit 6 ends the series of processes illustrated in FIG. 6.

Note that, regarding the scene determination process, it is also conceivable to cause the AI processing unit 5 to execute the determination as to whether or not the scene is a dark scene by providing a determination function of whether or not the scene is a dark scene as part of the AI model in the AI processing unit 5. In this case, the in-sensor control unit 6 performs control of the selector 39 (and switching control of the AI model) on the basis of the result of the determination process as to whether or not it is a dark scene performed by the AI processing unit 5 as described above.

### 2. Second Embodiment

Next, the second embodiment will be described.

In the second embodiment, the non-demosaic image is accumulated on the assumption that the AI model used in the AI processing unit 5 is retrained.

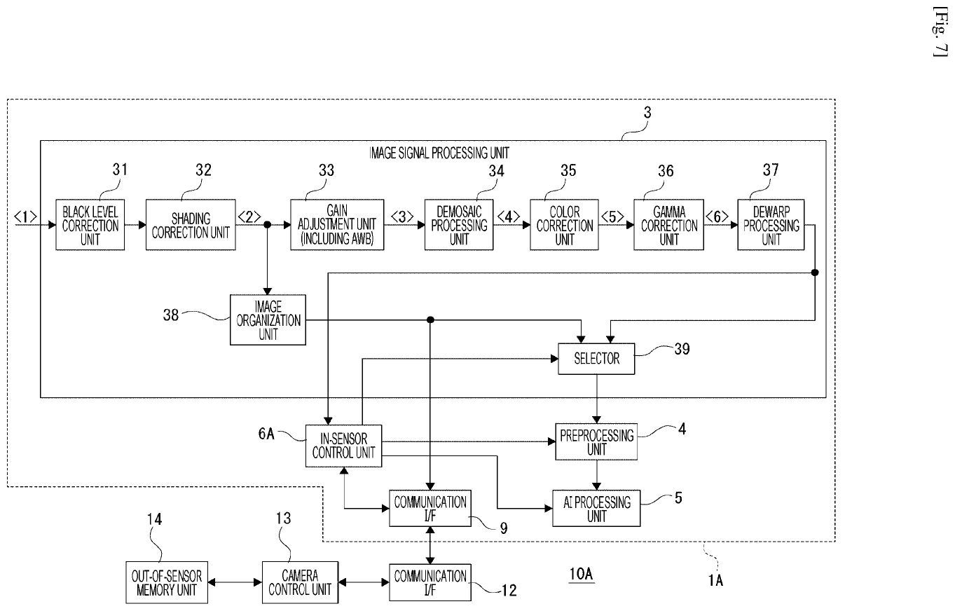

FIG. 7 is a block diagram for describing a configuration example of a camera device 10A as the second embodiment having a non-demosaic image accumulation function.

Note that, although illustration of the optical system 11 and illustration of the pixel array unit 2, the in-sensor memory unit 7, and the output data generation unit 8 are omitted in FIG. 7 for convenience of illustration, the camera device 10A of the second embodiment also includes the optical system 11, the pixel array unit 2, the in-sensor memory unit 7, and the output data generation unit 8 as in the case of the camera device 10. Although illustration of the first AI model setting data P1 and the second AI model setting data P2 is omitted in the out-of-sensor memory unit 14, the first AI model setting data P1 and the second AI model setting data P2 are also stored in the out-of-sensor memory unit 14 in the camera device 10A as in the case of the camera device 10.

In the following description, the same reference numerals are given to portions similar to those already described, and description thereof will be omitted.

The camera device 10A is different from the camera device 10 illustrated in FIG. 1 in that a sensor unit 1A is provided instead of the sensor unit 1.

The sensor unit 1A is different from the sensor unit 1 in that an in-sensor control unit 6A is provided instead of the in-sensor control unit 6.

The in-sensor control unit 6A is different from the in-sensor control unit 6 in that the in-sensor control unit 6A performs a process for accumulating non-demosaic images in a memory in the camera device 10A, specifically, in the present example, in the out-of-sensor memory unit 14.

As illustrated, in the sensor unit 1A, the non-demosaic image by the color separation image generated by the image organization unit 38 can be input not only to the selector 39 but also to the communication interface 9.

The in-sensor control unit 6A causes the camera control unit 13 to transmit the non-demosaic image by the color separation image via the communication interface 9, and instructs the camera control unit 13 to store the non-demosaic image in the out-of-sensor memory unit 14 via the communication interface 9.

As a result, the captured image by the non-demosaic image that can be obtained under the actual use environment of the camera device 10A can be accumulated in the out-of-sensor memory unit 14.

Furthermore, the in-sensor control unit 6A performs a process of transmitting the non-demosaic image accumulated in the out-of-sensor memory unit 14 to the outside of the camera device 10A. Specifically, the in-sensor control unit 6A instructs the camera control unit 13 to execute processing of transmitting the non-demosaic image accumulated in the out-of-sensor memory unit 14 to the external device on the basis of an instruction from the external device (for example, a server device or the like) of the camera device 10A.

As a result, it is possible to transmit the non-demosaic image to be used for retraining to the external device corresponding to a case where the retraining of the AI model used by the AI processing unit 5 is performed by the external device.

Note that, although the configuration in which the in-sensor control unit 6A instructs the camera control unit 13 to execute the transmission process for the accumulated non-demosaic image is described above, it is also conceivable that the camera control unit 13 performs the transmission process for the accumulated non-demosaic image on the basis of an instruction from the outside.

Furthermore, in the above description, an example is described in which the accumulation unit that accumulates the non-demosaic image is the out-of-sensor memory unit 14, but the accumulation unit may be a memory in the sensor unit 1A such as the in-sensor memory unit 7.

Here, in a case where the sensor unit 1A includes a communication unit capable of directly communicating with an external device of the camera device 10A, an execution entity of the process of transmitting the accumulated non-demosaic image may be the in-sensor control unit 6A.

### 3. Modifications

Note that the embodiment is not limited to the specific example described above, and may be configured as various modifications.

For example, it is also conceivable to change the signal processing parameter of the image signal processing unit 3 on the basis of the scene determination result. As an example, it is conceivable to change the parameter for the gain adjustment process as the overall gain adjustment described above by the gain adjustment unit 33 and the parameter for the gamma correction process by the gamma correction unit 36 on the basis of the determination result as to whether or not it is a dark scene. Specifically, it is conceivable to perform gamma correction and overall gain adjustment using a parameter for preventing black crushing in a case where the target subject has a dark scene, and to perform gamma correction and overall gain adjustment using a parameter for preventing overexposure in a case where the target subject is bright as a bright scene (in a case where not a dark scene).

Here, the parameter adjustment according to the dark scene/bright scene as described above is an effective method in a case where the object detection process is performed as the image analysis process using the AI model.

In a case where a segmentation process such as semantic segmentation is performed as the image analysis process using an AI model, class identification is performed for each block such as each pixel in the segmentation process. Therefore, when gamma correction or overall gain adjustment is performed, processing accuracy in a block of a bright portion or a dark portion may deteriorate.

Therefore, in a case where the segmentation process is performed as the image analysis process using an AI model, it is conceivable to use a captured image in a state where gamma correction or overall gain adjustment is not performed as input data.

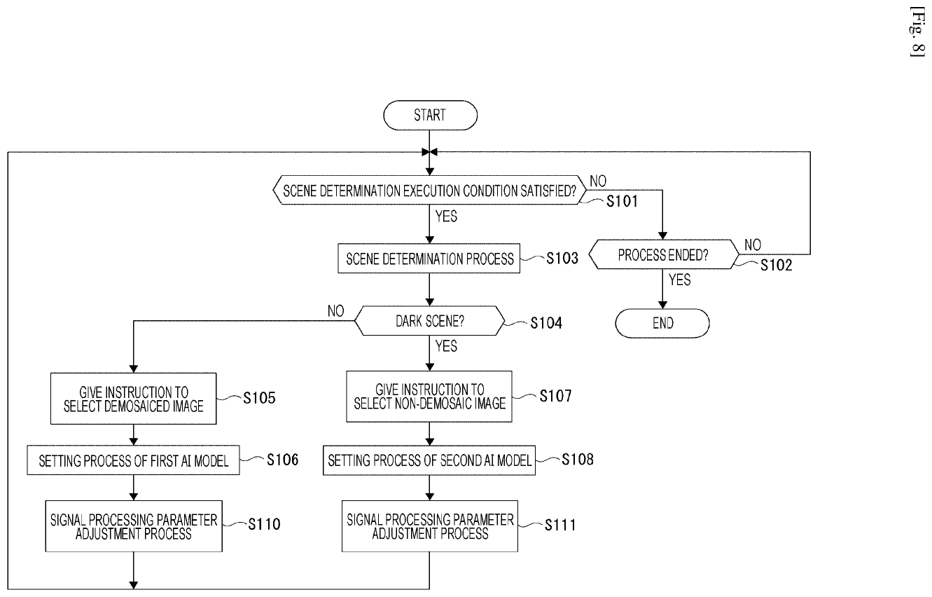

FIG. 8 is a flowchart illustrating a specific processing procedure example for realizing an analysis processing method as a modification in which the signal processing parameter of the image signal processing unit 3 is changed on the basis of the scene determination result as described above.

Here, the processing illustrated in FIG. 8 may be performed by either the in-sensor control unit 6 or the in-sensor control unit 6A, but the processing will be described here as being executed by the in-sensor control unit 6.

The processing illustrated in FIG. 8 is different from the processing illustrated in FIG. 6 in that the processing of steps S110 and S111 in the drawing is added.

Specifically, the in-sensor control unit 6 in this case performs the signal processing parameter adjustment process in step S110 in response to the execution of the setting process of the first AI model in step S106. In the present example, as the signal processing parameter adjustment process in step S110, corresponding to a case where it is determined that the scene is not a dark scene, processing of performing control is performed so that the parameter for preventing the overexposure is set in the gain adjustment unit 33 and the gamma correction unit 36.

In addition, the in-sensor control unit 6 in this case performs the signal processing parameter adjustment process in step S111 in response to the execution of the setting process of the second AI model in step S108. Specifically, as the signal processing parameter adjustment process in step S111 in the present example, corresponding to a case where it is determined that the scene is a dark scene, processing of performing control is performed so that the above-described parameter for preventing black crushing is set in the gain adjustment unit 33 and the gamma correction unit 36.

In this case, the in-sensor control unit 6 returns the process to step S101 even in a case where any signal processing parameter adjustment process of steps S110 and S111 is performed.

Note that, in the above, an example is described in which the parameters related to the overall gain adjustment and the gamma correction are changed on the basis of the scene determination result. However, as the parameters to be changed on the basis of the scene determination result, for example, another parameter such as an AWB parameter may be considered.

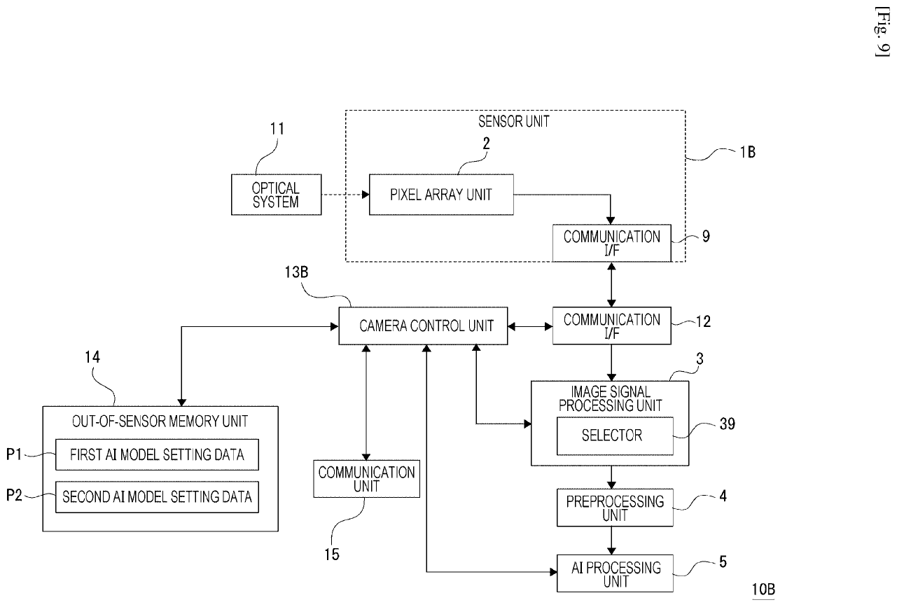

Furthermore, in the above description, the configuration in which the AI processing unit 5 is provided in the sensor device has been exemplified, but it is also conceivable to have a configuration in which the AI processing unit 5 is provided outside the sensor device as in the camera device 10B illustrated in FIG. 9.

Specifically, in the camera device 10B, a sensor unit 1B including only the pixel array unit 2 and the communication interface 9 is provided instead of the sensor unit 1 (or the sensor unit 1A). In this case, the image signal processing unit 3, the pre-processing unit 4, and the AI processing unit 5 are provided outside the sensor unit 1B. Furthermore, a camera device 10B includes a camera control unit 13B instead of the camera control unit 13.

As illustrated, in the camera device 10B, a captured image as RAW data obtained by the pixel array unit 2 is input to the image signal processing unit 3 via the communication interface 9 and the communication interface 12. Then, the image data selected by the selector 39 of the image signal processing unit 3 is input to the AI processing unit 5 via the preprocessing unit 4.

As in the in-sensor control unit 6, the camera control unit 13B controls the selector 39 based on the scene determination result. In addition, the camera control unit 13B performs the AI model setting process of the AI processing unit 5 on the basis of the first AI model setting data P1 and the second AI model setting data P2 stored in the out-of-sensor memory unit 14, as in the in-sensor control unit 6.

Furthermore, in a case where the non-demosaic image accumulation described in the second embodiment is realized, the camera control unit 13B performs a process of storing the non-demosaic image obtained by the image signal processing unit 3 in a memory in the camera device 10B such as the out-of-sensor memory unit 14. Furthermore, in this case, the camera control unit 13B can also perform processing of transmitting the accumulated non-demosaic image to an external device.

Furthermore, in the above description, an example is described in which the color separation image is used as the non-demosaic image to be input to the AI processing unit 5, but a non-demosaic image in a data format other than the color separation image can be given as input data of the AI processing unit 5.

Furthermore, in the above description, regarding the input data switching of the AI processing unit 5, an example is described in which the demosaiced image/ non-demosaic image is switched on the basis of the determination result as to whether or not it is a dark scene. However, it is also conceivable to switch the demosaiced image/non-demosaic image on the basis of a criterion other than the determination result as to whether or not it is a dark scene.

For example, it is conceivable to switch the input data to the non-demosaic image in a case where the target subject is imaged in a small size and resolution is requested, and switch the input data to the demosaiced image in a scene where the target subject is imaged in a large size.

Furthermore, as the scene determination, it is also conceivable to adopt a configuration in which three or more scenes are determined and the extraction position of the input data of the AI processing unit 5 is changed for each scene. For example, the input data may be a non-demosaic image after shading correction in the first scene, the input data may be a non-demosaic image after AWB processing in the second scene, and the input data may be a demosaiced image in the third scene.

Furthermore, in the above description, the case where the pixel array unit 2 is configured to separately receive only three wavelengths of R, G, and B has been exemplified. However, the present technology can also be suitably applied to a case where a pixel array unit configured to separately receive light of four or more wavelength bands, such as a pixel array unit in a multi spectrum camera, is used.

Furthermore, in the AI processing unit 5, in a case where it is assumed that a plurality of AI models having different analysis tasks is switched and used, it is also conceivable to determine whether or not to set the input data of the AI processing unit 5 to a non-demosaic image according to the type of AI model used by the AI processing unit 5 (that is, the type of analysis task).

### 5. Summary of Embodiment

As described above, the signal processing device (sensor unit 1, 1A, camera device 10B) as the embodiment includes an AI processing unit (5) that performs an image analysis process using an AI model with a non-demosaic image as input data, the non-demosaic image being a captured image in a state not subjected to a demosaic process, the captured image being obtained by a pixel array unit (2) configured by a plurality of pixel units two-dimensionally disposed, each pixel unit including a plurality of pixels receiving light of different wavelength bands, the plurality of pixels being two-dimensionally disposed in a predetermined pattern.

Since the demosaic process involves a spatial interpolation process, deviation from the original pixel value tends to occur, and in a case where the demosaiced image is used as input data of the image analysis process by the AI model, the processing accuracy may decrease due to the deviation of the pixel value. By using the non-demosaic image as the input data of the image analysis process as described above, it is possible to prevent degradation in processing accuracy due to such a demosaic process. Therefore, the processing accuracy of the image analysis process using the AI model can be improved.

Furthermore, the signal processing device as an embodiment includes a demosaic processing unit (34) that performs a demosaic process on a captured image obtained by the pixel array unit; and a control unit (in-sensor control unit 6, 6A, camera control unit 13B) that performs control so that input data of the AI processing unit is switched between a demosaiced image and the non-demosaic image on a basis of a scene determination result for a scene to be imaged, the demosaiced image being an image after the demosaic process by the demosaic processing unit.

As described with reference to FIG. 3, it has been confirmed by an experiment that the accuracy of the image analysis process may be improved by using the non-demosaic image instead of the demosaiced image depending on the scene. That is, even when a model that does not have a function of absorbing a difference between scenes is used as the AI model, the accuracy of the image analysis process may be improved by adopting a method of using a non-demosaic image instead of a demosaiced image in a certain scene.

As described above, by switching the input data of the AI processing unit between the demosaiced image and the non-demosaic image on the basis of the scene determination result, the non-demosaic image can be used as the input data in a specific scene in which the image analysis processing accuracy is improved in a case where the non-demosaic image is used as the input data.

Therefore, even in a case where an AI model capable of absorbing a difference between scenes cannot be used due to a resource problem, it is possible to suppress degradation in image analysis processing accuracy depending on scenes.

Furthermore, in the signal processing device as the embodiment, the control unit performs control so that an AI model trained with a demosaiced image as input data for training is used as the AI model in a case where the demosaiced image is input data, and an AI model trained with a non-demosaic image as input data for training is used as the AI model in a case where the non-demosaic image is input data.

As a result, as the image analysis process using the AI model, appropriate image analysis process according to the scene can be executed.

Furthermore, in the signal processing device as an embodiment, the determination of the scene to be imaged is determination of whether or not the scene is a dark scene, and the control unit receives a non-demosaic image as input data in a case where it is determined that the scene is a dark scene.

As described with reference to FIG. 3, it has been confirmed that, in a dark scene, accuracy of the image analysis process may be improved by using a non-demosaic image instead of a demosaiced image.

Therefore, according to the above configuration, even in a case where the AI model capable of absorbing the difference between the scenes cannot be used due to the resource problem, it is possible to suppress degradation in the image analysis processing accuracy depending on the scene.

Furthermore, the signal processing device as an embodiment includes an image signal processing unit (3) that includes a demosaic processing unit and performs an image signal process on a captured image, and the control unit changes a signal processing parameter of the image signal processing unit on the basis of a scene determination result (see FIG. 8).

As a result, it is possible to perform the image signal process suitable for a non-demosaic image in a case where it is determined that the scene is a specific scene and the image analysis process using the non-demosaic image as input data is performed, and perform the image signal process suitable for a demosaiced image in a case where it is determined that the scene is not a specific scene and the image analysis process using the demosaiced image as input data is performed.

Therefore, the accuracy of the image analysis process can be improved.

Furthermore, in the signal processing device as the embodiment, the AI model is an AI model having a neural network as a CNN, the signal processing device includes an image organization unit (38) that collects pixel values for respective pixels having a same in-pixel-unit position from each of the pixel units and generates a color separation image that is an image formed by being disposed in different regions on a same image plane, and the AI processing unit performs the image analysis process using the color separation image as input data.

As a result, the format of the input data to the AI processing unit is an input data format suitable for the configuration of the CNN.

Therefore, the accuracy of the image analysis process can be improved.

Furthermore, in the signal processing device as the embodiment, the AI processing unit performs the image analysis process using the non-demosaic image after shading correction as input data.

As described with reference to FIG. 3, in a scene in which a non-demosaic image should be used as input data, use of a non-demosaic image after shading correction can improve analysis processing accuracy, compared with use of a non-demosaic image before shading correction.

Therefore, according to the above configuration, the analysis processing accuracy can be improved corresponding to a specific scene such as a dark scene.

Furthermore, the signal processing device (sensor unit 1A and camera device 10B) as an embodiment includes an accumulation unit (in-sensor memory unit 7, out-of-sensor memory unit 14) that accumulates non-demosaic images.

The non-demosaic images accumulated in the accumulation unit can be used for re-training of the AI model used in the AI processing unit.

As the AI model can be retrained, the accuracy of the image analysis process by the AI processing unit can be improved.

Furthermore, the signal processing device as an embodiment includes a transmission processing unit (camera control unit 13, in-sensor control unit 6A, camera control unit 13B) that performs a process of transmitting the non-demosaic images accumulated in the accumulation unit to the outside of the device.

As a result, it is possible to transmit the non-demosaic image to be used for retraining to the external device corresponding to a case where the retraining of the AI model is performed by the external device of the signal processing device.

Therefore, retraining of the AI model can be appropriately performed.

Furthermore, the signal processing device (sensor unit 1, 1A) as an embodiment is configured as a sensor device including a pixel array unit.

As a result, the accuracy of the image analysis process can be improved for the sensor device configured to be capable of performing the image analysis process using the AI model.

In addition, a signal processing method as an embodiment includes performing an image analysis process using an AI model with a non-demosaic image as input data, the non-demosaic image being a captured image in a state not subjected to a demosaic process, the captured image being obtained by a pixel array unit including a plurality of pixel units two-dimensionally disposed, each pixel unit including a plurality of pixels two-dimensionally disposed in a predetermined pattern, the plurality of pixels receiving light in different wavelength bands.

With such a signal processing method, it is possible to obtain functions and effects similar to functions and effects of the signal processing devices as the above-described embodiments.

Note that effects described in the present description are merely examples and are not limited, and other effects may be provided.

### 6. Present Technology

The present technology can also adopt the following configurations.
(1)

An image processing system, comprising:
circuitry configured to
   acquire image data captured by an image sensor,
   process the image data to generate a non-demosaic image, and
   selectively output the non-demosaic image to an artificial intelligence model trained to perform image analysis.
(2)

The image processing system of (1), wherein the non-demosaic image is a captured image in a state not subjected to a demosaic process.
(3)

The image processing system of (2), wherein the non-demosaic image is the captured image in the state not subjected to a demosaic process and after shading correction.
(4)

The image processing system of (1), further comprising:
a memory configured to store one or more non-demosaic images.
(5)

The image processing system of (4), wherein the circuitry is further configured to retrain the artificial intelligence model using the one or more non-demosaic images stored in the memory.
(6)

The image processing system of (1), wherein the artificial intelligence model is a convolutional neural network.
(7)

The image processing system of (1), wherein the circuitry is further configured to
determine whether a scene corresponding to the acquired image data is a dark scene.
(8)

The image processing system of (7), wherein the scene is a dark scene in a case that a luminance value of a target subject is equal to or less than a predetermined luminance value.
(9)

The image processing system of (7), wherein the circuitry is further configured to
in response to a determination that the scene is the dark scene, select the non-demosaic image.
(10)

The image processing system of (9), wherein the non-demosaic image is a color separation image of the non-demosaic image.
(11)

The image processing system of (9), wherein the circuitry is further configured to
acquire artificial intelligence model setting data,
   perform parameter setting for the artificial intelligence model based on the acquired artificial intelligence model setting data,
   wherein, based on the parameter setting, the artificial intelligence model is an artificial intelligence model trained with non-demosaic images as input for training.
(12)

The image processing system of (10), wherein the artificial intelligence model setting data includes filter coefficients used in a convolution process in a convolutional neural network and a structure of the convolutional neural network.
(13)

The image processing system of (7), wherein the circuitry is further configured to
in a case that it cannot be determined whether a scene corresponding to the acquired image data is the dark scene, select the non-demosaic image.
(14)

The image processing system of (7), wherein the circuitry is further configured to
in response to a determination that the scene is not the dark scene, selectively output a demosaic image to the artificial intelligence model trained to perform image analysis.
(15)

The image processing system of (1), further comprising:
the image sensor configured to capture the image data.
(16)

An image processing system, comprising:
an image sensor configured to capture image data;
a processor configured to
   acquire the image data captured by the image sensor,
   process the image data to generate a non-demosaic image, and
   selectively output the non-demosaic image to an artificial intelligence model trained to perform image analysis; and
   a communication interface configured to output an image analysis result of the trained artificial intelligence model to a camera processing circuity.
(17)

An image processing method, comprising:
acquiring image data captured by an image sensor; processing the image data to generate a non-demosaic image; and selectively outputting the non-demosaic image to an artificial intelligence model trained to perform image analysis.
(18)

The method of (17), further comprising:
determining whether a scene corresponding to the acquired image data is a dark scene. (19)

The method of (17), further comprising:
in response to a determination that the scene is the dark scene, selecting the non-demosaic image, wherein the non-demosaic image is a color separation image of the non-demosaic image.
(20)

The method of (19), further comprising:
acquiring artificial intelligence model setting data, performing parameter setting for the artificial intelligence model based on the acquired artificial intelligence model setting data,
   wherein, based on the parameter setting, the artificial intelligence model is an artificial intelligence model trained with non-demosaic images as input for training.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10, 10A, 10B Camera device
1, 1A, 1B sensor unit
2 pixel array unit
3 image signal processing unit
4 preprocessing unit
5 AI processing unit
6, 6A in-sensor control unit
7 in-sensor memory unit
8 output data generation unit
9 communication interface (I/F)
11 optical system
12 communication interface (I/F)
13, 13B camera control unit
14 out-of-sensor memory unit
15 communication unit
P1 first AI model setting data
P2 second AI model setting data
31 black level correction unit
32 shading correction unit
33 gain adjustment unit
34 demosaic processing unit
35 color correction unit
36 gamma correction unit
37 dewarp processing unit
38 image organization unit
39 selector
Pu pixel unit

1. An image processing system, comprising:
circuitry configured to
acquire image data captured by an image sensor,
process the image data to generate a non-demosaic image, and
selectively output the non-demosaic image to an artificial intelligence model trained to perform image analysis.

2. The image processing system of claim 1, wherein the non-demosaic image is a captured image in a state not subjected to a demosaic process.

3. The image processing system of claim 2, wherein the non-demosaic image is the captured image in the state not subjected to a demosaic process and after shading correction.

4. The image processing system of claim 1, further comprising:
a memory configured to store one or more non-demosaic images.

5. The image processing system of claim 4, wherein the circuitry is further configured to
retrain the artificial intelligence model using the one or more non-demosaic images stored in the memory.

6. The image processing system of claim 1, wherein the artificial intelligence model is a convolutional neural network.

7. The image processing system of claim 1, wherein the circuitry is further configured to
determine whether a scene corresponding to the acquired image data is a dark scene.

8. The image processing system of claim 7, wherein the scene is a dark scene in a case that a luminance value of a target subject is equal to or less than a predetermined luminance value.

9. The image processing system of claim 7, wherein the circuitry is further configured to
in response to a determination that the scene is the dark scene, select the non-demosaic image.

10. The image processing system of claim 9, wherein the non-demosaic image is a color separation image of the non-demosaic image.

11. The image processing system of claim 9, wherein the circuitry is further configured to
acquire artificial intelligence model setting data,
perform parameter setting for the artificial intelligence model based on the acquired artificial intelligence model setting data,
wherein, based on the parameter setting, the artificial intelligence model is an artificial intelligence model trained with non-demosaic images as input for training.

12. The image processing system of claim 10, wherein the artificial intelligence model setting data includes filter coefficients used in a convolution process in a convolutional neural network and a structure of the convolutional neural network.

13. The image processing system of claim 7, wherein the circuitry is further configured to
in a case that it cannot be determined whether a scene corresponding to the acquired image data is the dark scene, select the non-demosaic image.

14. The image processing system of claim 7, wherein the circuitry is further configured to
in response to a determination that the scene is not the dark scene, selectively output a demosaic image to the artificial intelligence model trained to perform image analysis.

15. The image processing system of claim 1, further comprising:
the image sensor configured to capture the image data.

16. An image processing system, comprising:
an image sensor configured to capture image data;
a processor configured to
acquire the image data captured by the image sensor,
process the image data to generate a non-demosaic image, and
selectively output the non-demosaic image to an artificial intelligence model trained to perform image analysis; and
a communication interface configured to output an image analysis result of the trained artificial intelligence model to a camera processing circuity.

17. An image processing method, comprising:
acquiring image data captured by an image sensor;
processing the image data to generate a non-demosaic image; and
selectively outputting the non-demosaic image to an artificial intelligence model trained to perform image analysis.

18. The method of claim 17, further comprising:
determining whether a scene corresponding to the acquired image data is a dark scene.

19. The method of claim 18, further comprising:
in response to a determination that the scene is the dark scene, selecting the non-demosaic image, wherein the non-demosaic image is a color separation image of the non-demosaic image.

20. The method of claim 19, further comprising:
acquiring artificial intelligence model setting data, performing parameter setting for the artificial intelligence model based on the acquired artificial intelligence model setting data,
wherein, based on the parameter setting, the artificial intelligence model is an artificial intelligence model trained with non-demosaic images as input for training.
